(19) United States
(12) Patent Application Publication
(10) Pub. No.: US 2024/0056258 A1
(43) Pub. Date: Feb. 15, 2024

(54) SOUNDING REFERENCE SIGNAL ENHANCEMENT FOR EIGHT TRANSMIT UPLINK OPERATION

(71) Applicant: APPLE INC., Cupertino, CA (US)

(72) Inventors: Haitong Sun, Cupertino, CA (US); Wei Zeng, Saratoga, CA (US); Hong He, San Jose, CA (US); Dawei Zhang, Saratoga, CA (US); Sigen Ye, San Diego, CA (US); Ankit Bhamri, Bad Nauheim (DE); Jie Cui, San Jose, CA (US); Seyed Ali Akbar Fakoorian, San Diego, CA (US)

(21) Appl. No.: 18/339,632

(22) Filed: Jun. 22, 2023

Related U.S. Application Data
(60) Provisional application No. 63/371,206, filed on Aug. 11, 2022.

(51) Int. Cl. H04L 5/00; H04B 7/06

(52) U.S. Cl. CPC H04L 5/0051; H04B 7/061

(57) ABSTRACT

Systems and methods for sounding reference signal (SRS) enhancement for eight transmit (Tx) uplink (UL) operation are discussed. Embodiments herein relate to the design and use of SRS resource sets (and SRS resources therein) corresponding to eight Tx UL operation. Embodiments of eight transmit eight receive (Rx) (8T8R) antenna switching operation are discussed. Further, embodiments of eight Tx UL operation codebook physical uplink shared channel (PUSCH) operation are discussed. Still further, embodiments of eight Tx UL non-codebook PUSCH operation are discussed. Still further, embodiments for eight Tx UL operation applicable in either/both codebook and non-codebook PUSCH cases are discussed.

### TECHNICAL FIELD

This application relates generally to wireless communication systems, including wireless communication systems that perform eight transmit uplink operations.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of a UE, according to embodiments discussed herein.

FIG. 2 illustrates a method of a RAN, according to embodiments discussed herein.

FIG. 3 illustrates a diagram illustrating the use of two SRS resources to complete eight Tx SRS sounding, according to embodiments herein.

FIG. 4 illustrates a diagram of an SRS resource set, according to embodiments herein.

FIG. 5 illustrates a method of a UE, according to embodiments discussed herein.

FIG. 6 illustrates a method of a RAN, according to embodiments discussed herein.

FIG. 7 illustrates a diagram showing a use of SRS resource sets, according to embodiments herein.

FIG. 8 illustrates a diagram showing two SRS resource sets, according to embodiments herein.

FIG. 9 illustrates a method of a UE, according to embodiments discussed herein.

FIG. 10 illustrates a method of a RAN, according to embodiments discussed herein.

FIG. 11 illustrates a method of a UE, according to embodiments discussed herein.

FIG. 12 illustrates a method of a RAN, according to embodiments discussed herein.

FIG. 13 illustrates a diagram showing a mapping of SRS resource sets to TRPs, according to embodiments herein.

FIG. 14 illustrates a method of a UE, according to embodiments discussed herein.

FIG. 15 illustrates a method of a RAN, according to embodiments discussed herein.

FIG. 16 illustrates an example architecture of a wireless communication system, according to embodiments disclosed herein.

FIG. 17 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communications systems, sounding reference signal (SRS) design may contemplate that, for example, an SRS may only be transmitted in the last 6 symbols of each slot, that an SRS may be repeated up to 4 symbols, and/or that SRSs only support Comb 1/2/4.

Then, in some wireless communication systems that implement SRS enhancement(s), it may be that, for example, an SRS can be transmitted in any symbol in a slot, that SRSs support repetition with eight and 12 symbols, and/or that SRSs support Comb 8.

Further, in some wireless communications systems that implement further SRS enhancement(s), it may be that, for example, support for flexible aperiodic SRS (AP-SRS) triggering is present, that support for resource block (RB)-level partial frequency sounding (RPFS) is present, that SRSs support repetition with 10 and 14 symbols, and/or that SRSs support Comb 8 with 4 ports.

Herein, configurations under discussion may be referenced in terms of an antenna switching capability of a UE. The convention used may use the format “xTyR” to reference a particular antenna switching capability in terms of a number “x” of transmit antenna ports used for an SRS transmission for downlink (DL) channel sounding for a total number “y” of receive antenna ports. For example, a “1T1R” configuration is a configuration where a UE is capable of performing an SRS transmission on one transmit antenna port to sound the channel of one receive antenna port, a “2T4R” configuration is a configuration where a UE is capable of performing an SRS transmission on two transmit antenna ports to sound the DL channel of four receive antenna ports, etc.

For SRS antenna switching, some wireless communications systems may support, for example, antenna switching configurations of 1T1R, 1T2R, 1T4R, 1T6R, 1T8R, 2T2R, 2T4R, 2T6R, 2T8R, 4T4R, and/or 4T8R.

To implement multiple input multiple output (MIMO) evolutions for DL and/or uplink (UL), SRS enhancement for multiple transmission reception point (TRP) (multi-TRP) coherent joint transmission (CJT) operation may be considered. Use cases for such operation may be targeted to the use of, for example, handheld devices, customer premises equipment (CPE), fixed wireless access (FWA), vehicle, and/or industrial devices. Note that these use cases are given by way of example and not by way of limitation.

Embodiments herein relate to the design of enhanced SRS for eight transmit (Tx) UL operation. 8T8R antenna switching is discussed. Further, codebook physical uplink shared channel (PUSCH) operation is discussed. Still further, non-codebook PUSCH operation is discussed. Finally, general aspects for both codebook and non-codebook PUSCH operation are discussed.

8T8R Antenna Switching

In a first proposal for 8T8R antenna switching, it may be that a wireless communications system supports 8T8R antenna switching operation within a same (single) SRS resource set with usage configured as “antennaSwitching.” In such cases, it may be that one SRS resource is configured in the SRS resource set, and the SRS resource is configured with eight SRS ports. In some embodiments, the SRS resource set may be configured with resourceType=“semi-persistent” or “periodic” in such cases.

In some embodiments for 8T8R antenna switching, it may be that when a network configures a UE for 8T8R antenna switching operation, options for different resourceType settings or parameters corresponding to an SRS time domain pattern that applies to a configured SRS resource set may be as follows. For advanced UEs, where the UE supports a maximum of two semi-persistent SRS (SP-SRS) resource sets and one periodic SRS (P-SRS) resource set, the UE can be configured with up to two SRS resource sets configured with resourceType=“semi-persistent” and up to one SRS resource set configured with resourceType=“periodic.” Then, at any given time, a maximum of one of the (up to) two SP-SRS resource sets can be activated.

For other UEs (e.g., UEs that do not support the maximum of two SP-SRS resource sets along with one P-SRS resource set), the UE can be configured with up to two SRS resource sets for 8T8R antenna switching, and then one or both of the following options may be supported. In a first option, one P-SRS resource set and one SP-SRS resource set are configured. In a second option, two P-SRS resource sets are configured.

In some embodiments for 8T8R antenna switching, it may be that when a network configures a UE with 8T8R antenna switching operation, in terms of different resourceType (SRS time domain pattern), the use of aperiodic SRS resource set(s) is also supported (resourceType=“aperiodic”). In such cases, one or multiple of the following options can be configured at the UE.

In a first option, the network may configure at most one AP-SRS resource set for 8T8R antenna switching operation.

In a second option, when the network configures an AP-SRS resource set for 8T8R antenna switching operation, the network may further configure at most one P-SRS resource set for 8T8R antenna switching (without configuring any SP-SRS resource set).

In a third option, when the network configures an AP-SRS resource set for 8T8R antenna switching operation, the network may further configure at most one SP-SRS resource set for 8T8R antenna switching (without configuring any P-SRS resource set). Note that alternatively, for advanced UEs, the network may configure two SP-SRS resource sets in such cases (where one at a time may ultimately be activated).

In a fourth option, when the network configures an AP-SRS resource set for 8T8R antenna switching, the network may further configure at most one P-SRS resource set and one SP-SRS resource set for 8T8R antenna switching. Note that alternatively, for advanced UEs, the network may configure two SP-SRS resource sets (in addition to the P-SRS resource set) in such cases (where only one SP-SRS resource set at a time may ultimately be activated).

In some embodiments for 8T8R antenna switching operation, the UE may support UE 8T8R antenna switching capability reporting (the sending of an indication of whether UE supports 8T8R antenna switching operation). A UE may report an 8T8R antenna switching capability on a per feature set (FS) (per band per band combination (BC)) basis.

Further, with respect 8T8R antenna switching capability reporting, one of the following options may be implemented.

In a first option, the UE reports whether the UE supports 8T8R in capability report that is specified for 8T8R capability reporting. For capability reporting related to other antenna switching configuration(s), the UE may instead use, for example, a supportedSRS-TxPortSwitch-v1610 information element (IE) and/or an srs-TxSwitch IE, as may be available per a specification for some wireless communication systems.

In a second option, the UE reports whether the UE supports 8T8R and other antenna switching configuration(s) in the specified capability report mechanism, whether the other antenna switching configurations may include (but are not limited to) one or more antenna switching configurations from the set of {1T1R, 1T2R, 1T4R, 1T6R, 1T8R, 2T2R, 2T4R, 2T6R, 2T8R, 4T4R, 4T8R}.

In some embodiments for 8T8R antenna switching operation, it may be that when a UE reports that the UE supports 8T8R antenna switching operation, it may also report information related to an impacted DL band and/or an impacted UL band.

For example, the UE may report the impacted UL and/or impacted DL band in terms of which band is impacted. In some such cases, such an indication is used only when 8T8R antenna switching is configured. Otherwise (when 8T8R antenna switching is not configured), another capability reporting mechanism (for example, an srs-TxSwitch IE) may be used. In others of these cases, this indication is used regardless of the xTyR antenna switching configuration.

In some cases where the UE does not report an impacted band, it may be assumed that this there is no impact to a DL and/or UL band per the use of 8T8R antenna switching.

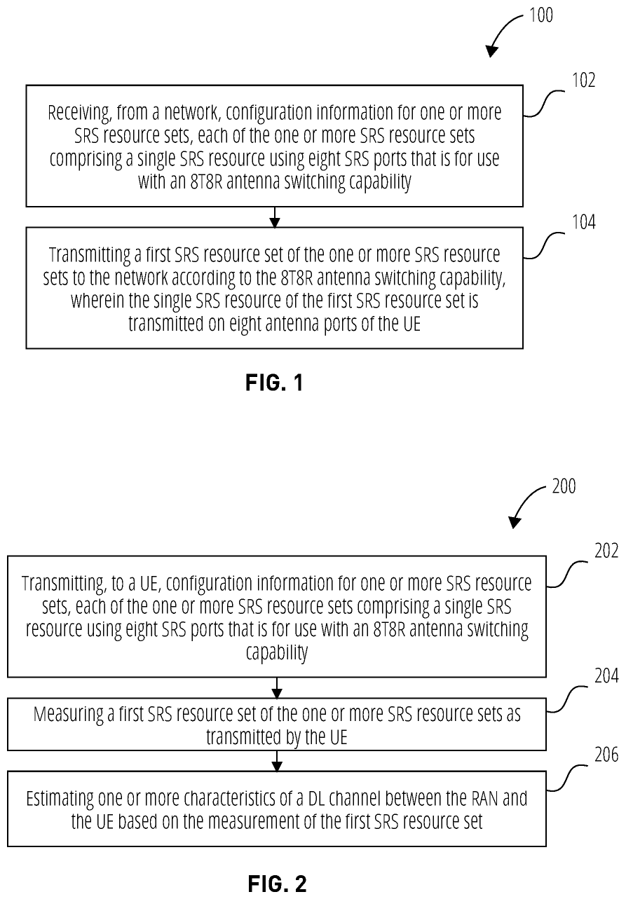

FIG. 1 illustrates a method 100 of a UE, according to embodiments discussed herein. The method 100 includes receiving 102, from a network, configuration information for one or more SRS resource sets, each of the one or more SRS resource sets comprising a single SRS resource using eight SRS ports that is for use with an 8T8R antenna switching capability. The method 100 further includes transmitting 104 a first SRS resource set of the one or more SRS resource sets to the network according to the 8T8R antenna switching capability, wherein the single SRS resource of the first SRS resource set is transmitted on eight antenna ports of the UE.

In some embodiments, the method 100 further includes transmitting, to the network, a first indication that the UE is capable of performing the 8T8R antenna switching capability with respect to a FS. In some such embodiments, the method 100 further includes transmitting, to the network, a second indication of a DL band that is impacted corresponding to a use of the 8T8R antenna switching capability with the first indication that the UE is capable of performing the 8T8R antenna switching capability with respect to the FS. In some such embodiments, the method 100 further includes transmitting, to the network, a second indication of an UL band that is impacted corresponding to a use of the 8T8R antenna switching capability with the first indication that the UE is capable of performing the 8T8R antenna switching capability with respect to the FS.

In some embodiments of the method 100, the one or more SRS resource sets comprises a first SP-SRS resource set and a P-SRS resource set. In some such embodiments, the one or more SRS resource sets further comprises a second SP-SRS resource set.

In some embodiments of the method 100, the one or more SRS resource sets comprises two P-SRS resource sets.

In some embodiments of the method 100, the one or more SRS resource sets comprises an AP-SRS resource set. In some such embodiments, the one or more SRS resource sets further comprises a P-SRS resource set.

In some such embodiments, the one or more SRS resource sets further comprises a first SP-SRS resource set. In some of these cases, the one or more SRS resource sets further comprises a second SP-SRS resource set.

In some such embodiments, the one or more SRS resource sets further comprises a P-SRS resource set and a first SP-SRS resource set. In some of these cases, the one or more SRS resource sets further comprises a second SP-SRS resource set.

FIG. 2 illustrates a method 200 of a RAN, according to embodiments discussed herein. The method 200 includes transmitting 202, to a UE, configuration information for one or more SRS resource sets, each of the one or more SRS resource sets comprising a single SRS resource using eight SRS ports that is for use with an 8T8R antenna switching capability. The method 200 further includes measuring 204 a first SRS resource set of the one or more SRS resource sets as transmitted by the UE. The method 200 further includes estimating 206 one or more characteristics of a DL channel between the RAN and the UE based on the measurement of the first SRS resource set.

In some embodiments, the method 200 further includes receiving, from the UE, a first indication that the UE is capable of performing the 8T8R antenna switching capability with respect to a FS. In some such embodiments, the method 200 further includes receiving, from the UE, a second indication of a DL band that is impacted corresponding to a use of the 8T8R antenna switching capability with the first indication that the UE is capable of performing the 8T8R antenna switching capability with respect to the FS. In some such embodiments, the method 200 further includes receiving, from the UE, a second indication of an UL band that is impacted corresponding to a use of the 8T8R antenna switching capability with the first indication that the UE is capable of performing the 8T8R antenna switching capability with respect to the FS.

In some embodiments of the method 200, the one or more SRS resource sets comprises a first SP-SRS resource set and a P-SRS resource set. In some such embodiments, the one or more SRS resource sets further comprises a second SP-SRS resource set.

In some embodiments of the method 200, the one or more SRS resource sets comprises two P-SRS resource sets.

In some embodiments of the method 200, the one or more SRS resource sets comprises an AP-SRS resource set. In some such embodiments, the one or more SRS resource sets further comprises a P-SRS resource set.

In some such embodiments, the one or more SRS resource sets further comprises a first SP-SRS resource set. In some such cases, the one or more SRS resource sets further comprises a second SP-SRS resource set.

In some such embodiments, the one or more SRS resource sets further comprises a P-SRS resource set and a first SP-SRS resource set. In some such cases, the one or more SRS resource sets further comprises a second SP-SRS resource set.

Codebook PUSCH Operation

Note that in the codebook-based embodiments discussed herein, eight Tx SRS sounding as described herein is performed to enable the network to select a precoder matrix indicator (PMI) and a rank indicator (RI) corresponding to the eight Tx SRS sounding and inform that PMI and RI back to the UE for PUSCH transmission.

In some embodiments for eight Tx UL codebook PUSCH operation, in a same (single) SRS resource set (SRS-ResourceSet with usage=“codebook”), it may be that two SRS resources can be used to complete eight Tx SRS sounding, where each of the two SRS resources is configured with four SRS ports.

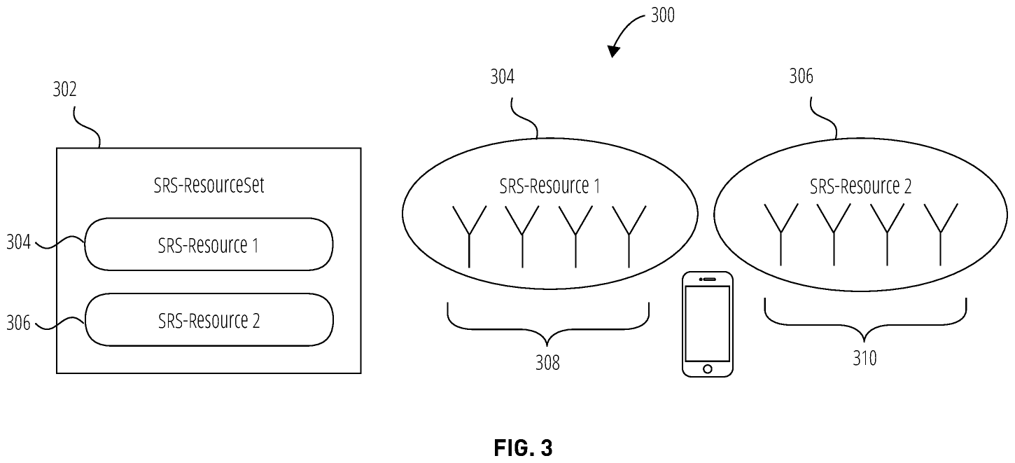

FIG. 3 illustrates a diagram 300 illustrating the use of two SRS resources 304, 306 to complete eight Tx SRS sounding, according to embodiments herein. An SRS resource set 302 includes a first SRS resource 304 and a second SRS resource 306. As illustrated, the first SRS resource 304 may use a first four antenna ports 308 for sounding, and the second SRS resource 306 may use a second four antenna ports 310 for sounding.

In some embodiments for eight Tx UL codebook PUSCH operation using a same (single) SRS resource set, when two SRS resources are configured in the SRS resource set to complete eight Tx SRS sounding, the Tx/antenna ports to SRS resource mapping may be established as follows.

For “coherent” and “nonCoherent” operation as between the antenna ports of the UE, the mapping may be up to UE implementation.

For “partialCoherent” operation as between the antenna ports of the UE, each coherent antenna port group may be mapped to a same SRS resource. In such cases, eight Tx “partialCoherent” operation may have at least two possibilities. A first possibility is that there are two coherent antenna port groups at the UE, each with four coherent antenna ports. A second possibility is that there are four coherent antenna port groups at the UE, each with two coherent antenna ports.

In some embodiments for eight Tx UL codebook PUSCH operation using a same (single) SRS resource set, and where ultimately a pair of SRS resources, each with four SRS ports are used to complete eight Tx SRS sounding, various cases exist. In first such cases where the network does not configure the UE to use a fullpower transmission mode 2, the network may configure up to two pairs of SRS resources (for four total SRS resources) in the SRS resource set. In such cases, all the SRS resources in the same SRS resource set may be configured with four SRS ports.

In second such cases where the network configures the UE to use fullpower transmission mode 2, the network may configure up to four pairs of SRS resources (for eight total SRS resources) in the SRS resource set. In such cases, each pair of SRS resources in the same SRS resource set may be configured with the same amount of SRS ports (where each pair uses eight SRS ports total), but different pairs of SRS resources can be configured with different numbers of SRS ports per each SRS resource in the pair.

In some embodiments for eight Tx UL codebook PUSCH operation using a same (single) SRS resource set, and where more than two SRS resources are configured in the SRS resource set to complete eight Tx SRS sounding, a mechanism to identify a pair of SRS resources from the SRS resource set to use for the eight Tx operation interprets an SRS resource indicator (SRI) field in a scheduling DCI. In such embodiments, the SRI is used to indicate an index of the pair of SRS resources from the SRS resource set to use for the eight Tx operation.

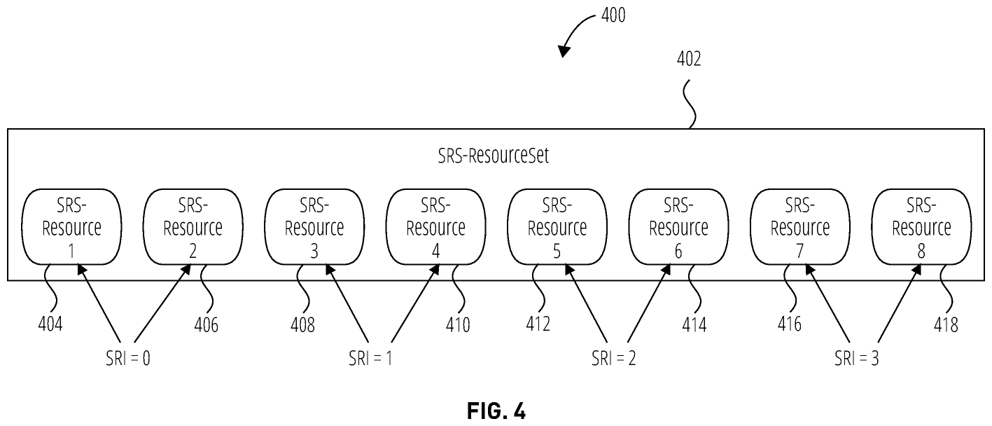

FIG. 4 illustrates a diagram 400 of an SRS resource set 402, according to embodiments herein. As illustrated, the SRS resource set 402 includes the first SRS resource 404, the second SRS resource 406, the third SRS resource 408, the fourth SRS resource 410, the fifth SRS resource 412, the sixth SRS resource 414, the seventh SRS resource 416, and the eighth SRS resource 418. As illustrated, a first SRI provides the index ‘0’ for a first pair of SRS resources made up of the first SRS resource 404 and the second SRS resource 406, a second SRI provides the index ‘1’ for a second pair of SRS resources made up of the third SRS resource 408 and the fourth SRS resource 410, a third SRI provides the index ‘2’ for a third pair of SRS resources made up of the fifth SRS resource 412 and the sixth SRS resource 414, and a fourth SRI provides the index ‘3’ for a fourth pair of SRS resources made up of the seventh SRS resource 416 and the eighth SRS resource 418.

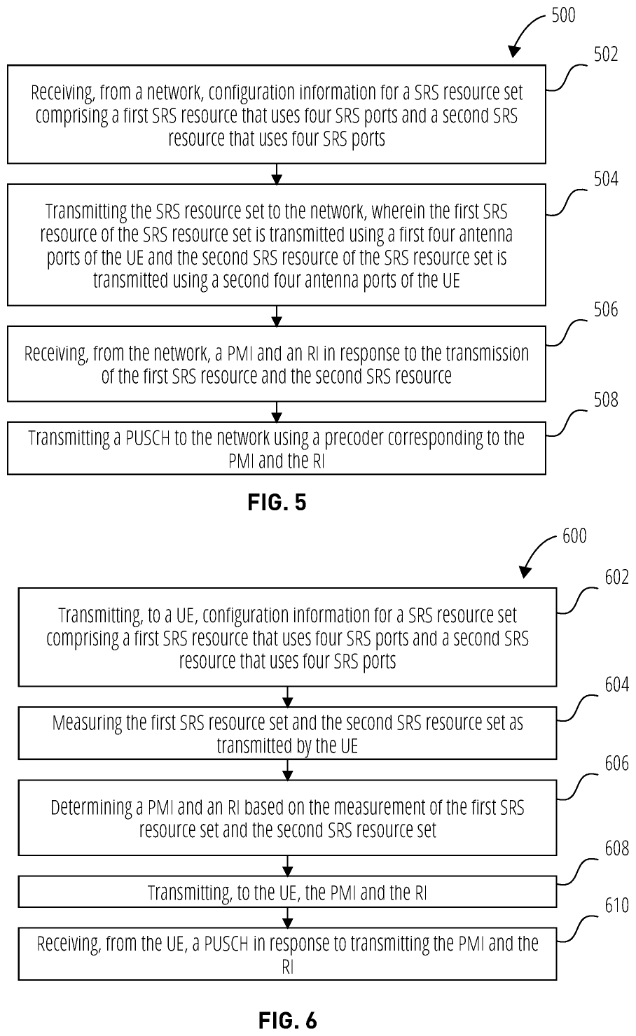

FIG. 5 illustrates a method 500 of a UE, according to embodiments discussed herein. The method 500 includes receiving 502, from a network, configuration information for an SRS resource set comprising a first SRS resource that uses four SRS ports and a second SRS resource that uses four SRS ports. The method 500 further includes transmitting 504 the SRS resource set to the network, wherein the first SRS resource of the SRS resource set is transmitted using a first four antenna ports of the UE and the second SRS resource of the SRS resource set is transmitted using a second four antenna ports of the UE. The method 500 further includes receiving 506, from the network, a PMI and an RI in response to the transmission of the first SRS resource and the second SRS resource. The method 500 further includes transmitting 508 a PUSCH to the network using a precoder corresponding to the PMI and the RI.

FIG. 6 illustrates a method 600 of a RAN, according to embodiments discussed herein. The method 600 includes transmitting 602, to a UE, configuration information for an SRS resource set comprising a first SRS resource that uses four SRS ports and a second SRS resource that uses four SRS ports. The method 600 further includes measuring 604 the first SRS resource set and the second SRS resource set as transmitted by the UE. The method 600 further includes determining 606 a PMI and an RI based on the measurement of the first SRS resource set and the second SRS resource set. The method 600 further includes transmitting 608, to the UE, the PMI and the RI. The method 600 further includes receiving 610, from the UE, a PUSCH in response to transmitting the PMI and the RI.

In some embodiments for eight Tx UL codebook PUSCH operation, for a same TRP, two SRS resource sets may be configured (two SRS-ResourceSets with usage=“codebook”) to complete eight Tx SRS sounding. In such cases, each SRS resource set may be configured with at least one SRS resource, where each such SRS resource is configured with 4 SRS ports.

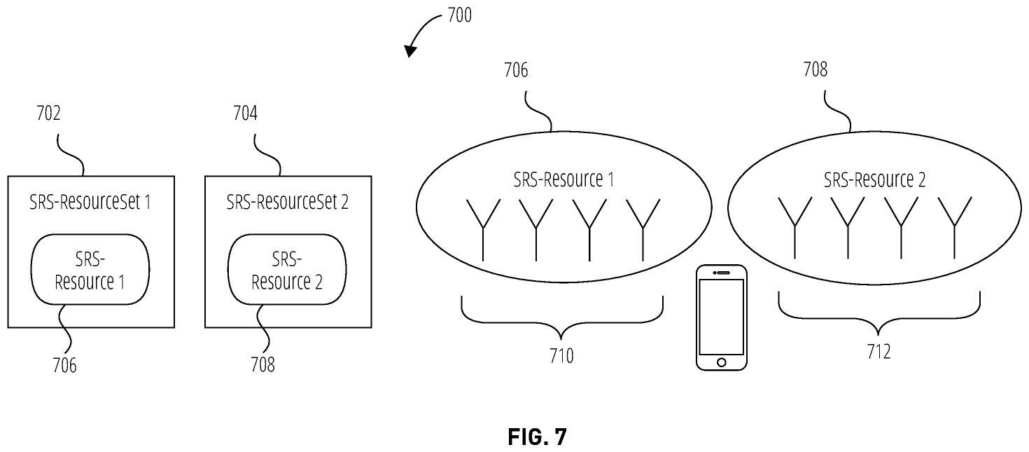

FIG. 7 illustrates a diagram showing a use of SRS resource sets 702, 704, according to embodiments herein. The first SRS resource set 702 includes a first SRS resource 706 and the second SRS resource set 704 includes a second SRS resource 708. Then, as illustrated, the first SRS resource 706 is configured for the first four antenna ports 710 and the second SRS resource 708 is configured for the second four antenna ports 712.

In some embodiments for eight Tx UL codebook PUSCH operation, when two SRS resource sets are configured to complete eight Tx SRS sounding, a Tx/antenna ports to SRS resource mapping may be established as follows.

For “coherent” and “nonCoherent” operation as between the antenna ports of the UE, the mapping may be up to UE implementation.

For “partialCoherent” operation as between the antenna ports of the UE, each coherent antenna port group may be mapped to a same SRS resource set. In such cases, eight Tx “partialCoherent” operation may have at least two possibilities. A first possibility is that there are two coherent antenna port groups at the UE, each with four coherent antenna ports. A second possibility is that there are four coherent antenna port groups at the UE, each with two coherent antenna ports.

In some embodiments for eight Tx UL codebook PUSCH operation, and where two SRS resource sets are configured to complete eight Tx SRS sounding using an SRS resource from each of the two SRS resource sets, it may be that the same number of SRS resources are configured in both SRS resource sets. In first such cases where the network does not configure the UE to use a fullpower transmission mode 2, the network may configure up to two SRS resources per SRS resource set, each with four SRS ports.

In second such cases where the network configures the UE to use a fullpower transmission mode 2, the network may configure up to four SRS resources per SRS resource set, each with a same or a different number of SRS ports. In such cases, it may be that same indexed pairs of SRS resources in different SRS resource sets (e.g., as will be described) are configured with a same number of SRS ports across the pair (e.g., where each such pair uses eight SRS ports).

In embodiments for eight Tx UL codebook PUSCH operation using a pair of SRS resource sets, and where more than one SRS resource is configured in each of the SRS resource sets to complete eight Tx SRS sounding, a mechanism to identify a pair of SRS resources across the pair of SRS resource sets to use for the eight Tx operation interprets an SRS resource indicator (SRI) field in a scheduling DCI. In such embodiments, the SRI is used to indicate an index of a pair of SRS resources across the pair of SRS resource sets.

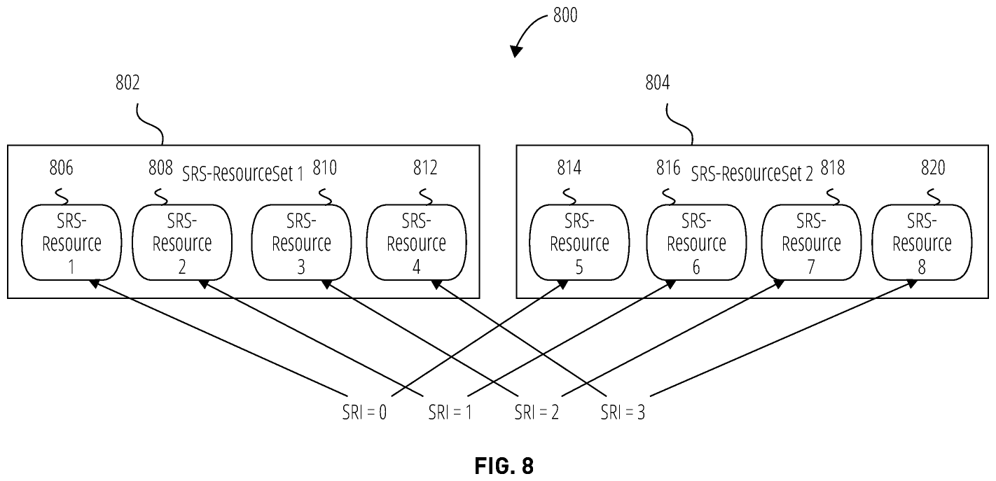

FIG. 8 illustrates a diagram 800 showing two SRS resource sets 802, 804, according to embodiments herein. As illustrated, the first SRS resource set 802 includes the first SRS resource 806, the second SRS resource 808, the third SRS resource 810, and the fourth SRS resource 812. Further, the second SRS resource set 804 includes the fifth SRS resource 814, the sixth SRS resource 816, the seventh SRS resource 818, and the eighth SRS resource 820. As illustrated, a first SRI provides the index ‘0’ for a first pair of SRS resources made up of the first SRS resource 806 of the first SRS resource set 802 and the fifth SRS resource 814 of the second SRS resource set 804, a second SRI provides the index ‘1’ for a second pair of SRS resources made up of the second SRS resource 808 of the first SRS resource set 802 and the sixth SRS resource 816 of the second SRS resource set 804, a third SRI provides the index ‘2’ for a third pair of SRS resources made up of the third SRS resource 810 of the first SRS resource set 802 and the seventh SRS resource 818 of the second SRS resource set 804, and a fourth SRI provides the index ‘3’ for a fourth pair of SRS resources made up of the fourth SRS resource 812 of the first SRS resource set 802 and the eighth SRS resource 820 of the second SRS resource set 804.

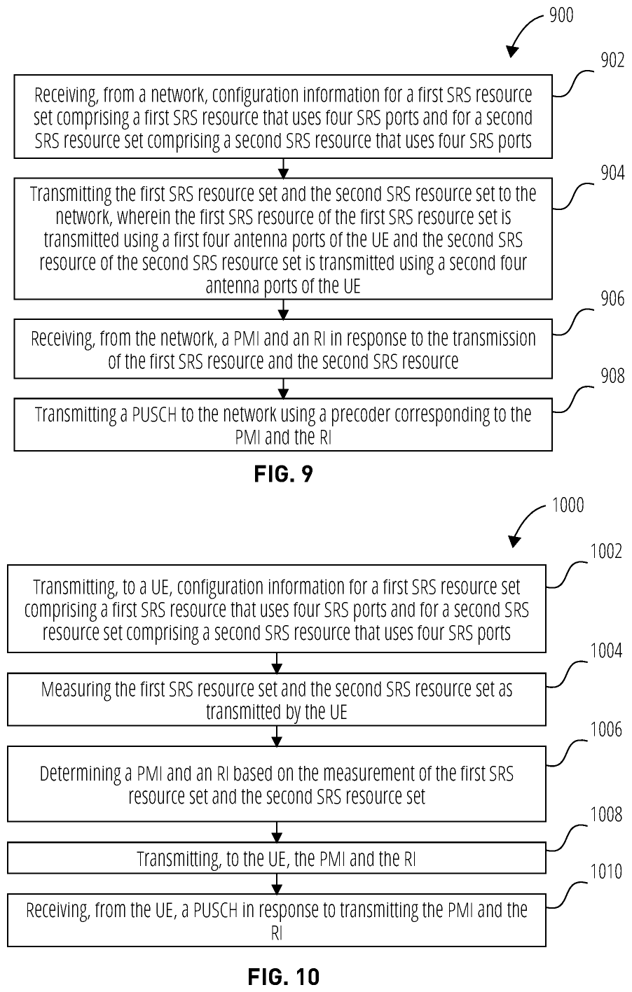

FIG. 9 illustrates a method 900 of a UE, according to embodiments discussed herein. The method 900 includes receiving 902, from a network, configuration information for a first SRS resource set comprising a first SRS resource that uses four SRS ports and for a second SRS resource set comprising a second SRS resource that uses four SRS ports. The method 900 further includes transmitting 904 the first SRS resource set and the second SRS resource set to the network, wherein the first SRS resource of the first SRS resource set is transmitted using a first four antenna ports of the UE and the second SRS resource of the second SRS resource set is transmitted using a second four antenna ports of the UE. The method 900 further includes receiving 906, from the network, a PMI and an RI in response to the transmission of the first SRS resource and the second SRS resource. The method 900 further includes transmitting 908 a PUSCH to the network using a precoder corresponding to the PMI and the RI.

FIG. 10 illustrates a method 1000 of a RAN, according to embodiments discussed herein. The method 1000 includes transmitting 1002, to a UE, configuration information for a first SRS resource set comprising a first SRS resource that uses four SRS ports and for a second SRS resource set comprising a second SRS resource that uses four SRS ports. The method 1000 further includes measuring 1004 the first SRS resource set and the second SRS resource set as transmitted by the UE. The method 1000 further includes determining 1006 a PMI and an RI based on the measurement of the first SRS resource set and the second SRS resource set. The method 1000 further includes transmitting 1008, to the UE, the PMI and the RI. The method 1000 further includes receiving 1010, from the UE, a PUSCH in response to transmitting the PMI and the RI.

Non-Codebook PUSCH Operation

Note that in the non-codebook-based embodiments discussed herein, eight Tx SRS sounding as described herein is performed to enable the network to select one or more SRSs back to the UE, such that corresponding antenna port(s) may be selected by the UE for PUSCH transmission.

In some embodiments for eight Tx UL non-codebook PUSCH operation, for a same TRP, two SRS resource sets may be configured (two SRS-ResourceSets with usage=“nonCodebook”) to complete eight Tx SRS sounding. In such cases, it may be that each SRS resource set is configured with four SRS resources. Further, each such SRS resource may be configured with one SRS port. It may also be that both SRS resource sets are configured with the same number of SRS resources.

In some cases, for such embodiments, SRS resources in different SRS resource sets do not overlap in a same symbol. In some cases for such embodiments, SRS resources in different SRS resource sets may overlap in the same symbol (e.g., subject to UE capability reporting).

In some embodiments for eight Tx UL non-codebook PUSCH operation, a mechanism for identifying one or more SRS resources from one or both of the SRS resource sets corresponding to antenna ports to be used for the PUSCH in response to the eight Tx SRS sounding interprets an SRI field in a scheduling DCI. In such cases, it may be that all the SRS resources from both SRS resource sets are combined/considered together when applying the SRI to identify SRS resource(s) therefrom. In such cases, for ordering purposes with respect to the use of the SRI, the SRS resource set with the smaller index (SRS-ResourceSetId) is ordered first. Accordingly, in such embodiments, an SRI field may be understood to apply with respect to the combined SRS resources from both SRS resource sets.

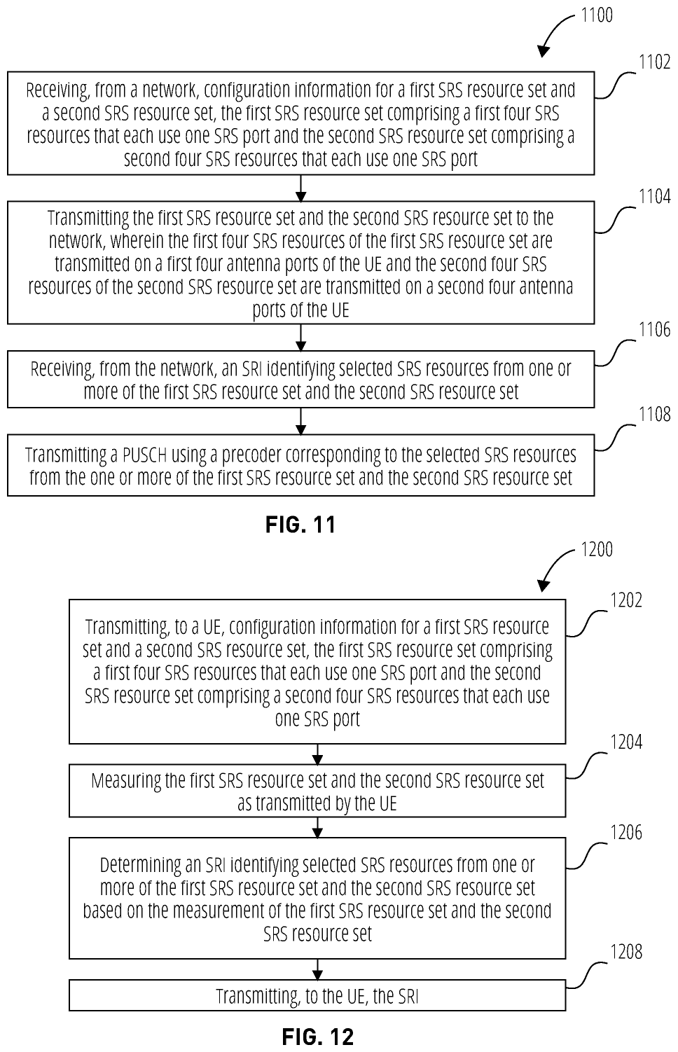

FIG. 11 illustrates a method 1100 of a UE, according to embodiments discussed herein. The method 1100 includes receiving 1102, from a network, configuration information for a first SRS resource set and a second SRS resource set, the first SRS resource set comprising a first four SRS resources that each use one SRS port and the second SRS resource set comprising a second four SRS resources that each use one SRS port. The method 1100 further includes transmitting 1104 the first SRS resource set and the second SRS resource set to the network, wherein the first four SRS resources of the first SRS resource set are transmitted on a first four antenna ports of the UE and the second four SRS resources of the second SRS resource set are transmitted on a second four antenna ports of the UE. The method 1100 further includes receiving 1106, from the network, an SRI identifying selected SRS resources from one or more of the first SRS resource set and the second SRS resource set. The method 1100 further includes transmitting 1108 a PUSCH using a precoder corresponding to the selected SRS resources from the one or more of the first SRS resource set and the second SRS resource set.

FIG. 12 illustrates a method 1200 of a RAN, according to embodiments discussed herein. The method 1200 includes transmitting 1202, to a UE, configuration information for a first SRS resource set and a second SRS resource set, the first SRS resource set comprising a first four SRS resources that each use one SRS port and the second SRS resource set comprising a second four SRS resources that each use one SRS port. The method 1200 further includes measuring 1204 the first SRS resource set and the second SRS resource set as transmitted by the UE. The method 1200 further includes determining 1206 an SRI identifying selected SRS resources from one or more of the first SRS resource set and the second SRS resource set based on the measurement of the first SRS resource set and the second SRS resource set. The method 1200 further includes transmitting 1208, to the UE, the SRI.

PUSCH Operation for Both Codebook and Non-Codebook

In some embodiments with respect to general PUSCH operation for both codebook and non-codebook cases, when a pair of (two) SRS resource sets is configured to complete the eight Tx SRS sounding, it may be that both SRS resource sets are configured with the same power control parameters/settings, including alpha, p0, and pathlossReferenceRS parameters. Note that in the case of non-codebook PUSCH operation, both SRS resource sets may be configured with a same associatedCSI-RS or NZP-CSI-RS-ResourceId.

Further, it may be that both SRS resource sets are configured with the same time domain pattern (resourceType).

Finally, in the case whether the pair of SRS resource sets are AP-SRS resource sets, both AP-SRS resource sets may be configured with the same aperiodicSRS-ResourceTrigger.

In some embodiments with respect to general PUSCH operation for both codebook and non-codebook cases, for multi-TRP support for both codebook and non-codebook PUSCH operation, when a pair of (two) SRS resource sets is configured to complete eight Tx SRS sounding, it may be that four SRS resource sets are configured. In such cases, the two SRS resource sets with the two smallest indexes (srs-ResourceSetId) are mapped to the first TRP, and the two SRS resource sets with the two largest indexes (srs-ResourceSetId) are mapped to the second TRP.

Then, for purposes of interpretation of an SRI field in scheduling DCI, the SRS resource sets with the two smallest indexes (mapped to the first TRP) may be treated as one SRS resource set within the multi-TRP operation, while the SRS resource sets with the two largest indexes (mapped to the second TRP) may be treated as one SRS resource set within the multi-TRP operation.

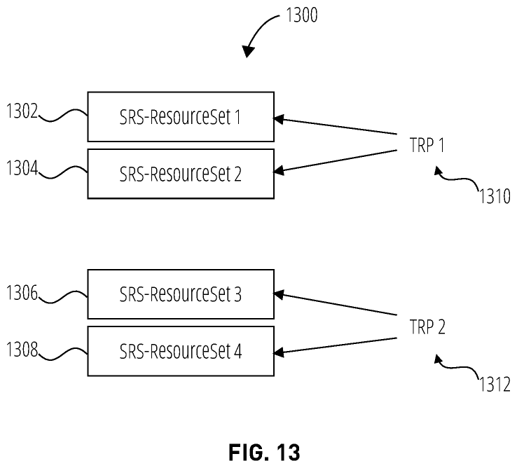

FIG. 13 illustrates a diagram 1300 showing a mapping of SRS resource sets to TRPs, according to embodiments herein. Of the four SRS resource sets 1302, 1304, 1306, and 1308, the first SRS resource set 1302 and the second SRS resource set 1304 have the two smallest indexes, and as such are mapped to the first TRP 1310. Further, of the four SRS resource sets 1302, 1304, 1306, and 1308, the third SRS resource set 1306 and the fourth SRS resource set 1308 have the two largest indexes, and as such are mapped to the second TRP 1312.

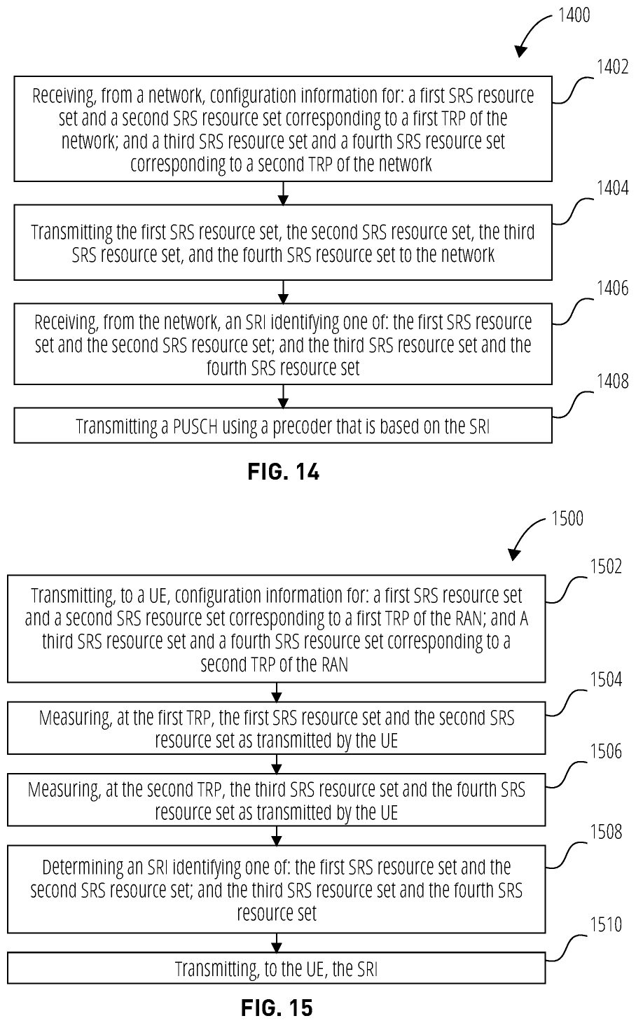

FIG. 14 illustrates a method 1400 of a UE, according to embodiments discussed herein. The method 1400 includes receiving 1402, from a network, configuration information for: a first SRS resource set and a second SRS resource set corresponding to a first TRP of the network; and a third SRS resource set and a fourth SRS resource set corresponding to a second TRP of the network. The method 1400 further includes transmitting 1404 the first SRS resource set, the second SRS resource set, the third SRS resource set, and the fourth SRS resource set to the network. The method 1400 further includes receiving 1406, from the network, an SRI identifying one of: the first SRS resource set and the second SRS resource set; and the third SRS resource set and the fourth SRS resource set. The method 1400 further includes transmitting 1408 a PUSCH using a precoder that is based on the SRI.

FIG. 15 illustrates a method 1500 of a RAN, according to embodiments discussed herein. The method 1500 includes transmitting 1502, to a UE, configuration information for: a first SRS resource set and a second SRS resource set corresponding to a first TRP of the RAN; and a third SRS resource set and a fourth SRS resource set corresponding to a second TRP of the RAN. The method 1500 further includes measuring 1504, at the first TRP, the first SRS resource set and the second SRS resource set as transmitted by the UE. The method 1500 further includes measuring 1506, at the second TRP, the third SRS resource set and the fourth SRS resource set as transmitted by the UE. The method 1500 further includes determining 1508 an SRI identifying one of: the first SRS resource set and the second SRS resource set; and the third SRS resource set and the fourth SRS resource set. The method 1500 further includes transmitting 1510, to the UE, the SRI.

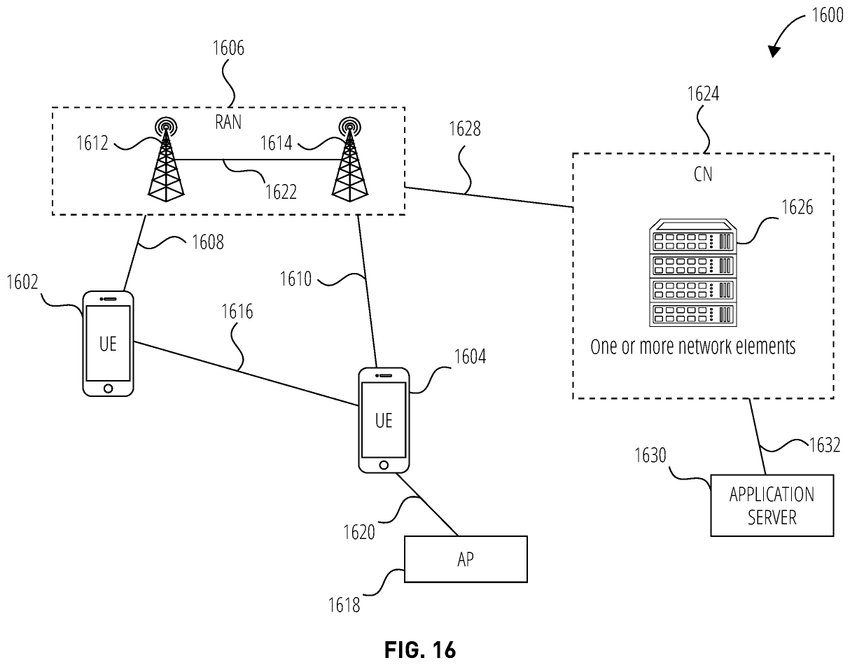

FIG. 16 illustrates an example architecture of a wireless communication system 1600, according to embodiments disclosed herein. The following description is provided for an example wireless communication system 1600 that operates in conjunction with the LTE system standards and/or 5G or NR system standards as provided by 3GPP technical specifications.

As shown by FIG. 16, the wireless communication system 1600 includes UE 1602 and UE 1604 (although any number of UEs may be used). In this example, the UE 1602 and the UE 1604 are illustrated as smartphones (e.g., handheld touchscreen mobile computing devices connectable to one or more cellular networks), but may also comprise any mobile or non-mobile computing device configured for wireless communication.

The UE 1602 and UE 1604 may be configured to communicatively couple with a RAN 1606. In embodiments, the RAN 1606 may be NG-RAN, E-UTRAN, etc. The UE 1602 and UE 1604 utilize connections (or channels) (shown as connection 1608 and connection 1610, respectively) with the RAN 1606, each of which comprises a physical communications interface. The RAN 1606 can include one or more base stations (such as base station 1612 and base station 1614) that enable the connection 1608 and connection 1610.

In this example, the connection 1608 and connection 1610 are air interfaces to enable such communicative coupling, and may be consistent with RAT(s) used by the RAN 1606, such as, for example, an LTE and/or NR.

In some embodiments, the UE 1602 and UE 1604 may also directly exchange communication data via a sidelink interface 1616. The UE 1604 is shown to be configured to access an access point (shown as AP 1618) via connection 1620. By way of example, the connection 1620 can comprise a local wireless connection, such as a connection consistent with any IEEE 802.11 protocol, wherein the AP 1618 may comprise a Wi-Fi® router. In this example, the AP 1618 may be connected to another network (for example, the Internet) without going through a CN 1624.

In embodiments, the UE 1602 and UE 1604 can be configured to communicate using orthogonal frequency division multiplexing (OFDM) communication signals with each other or with the base station 1612 and/or the base station 1614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1612 or base station 1614 may be implemented as one or more software entities running on server computers as part of a virtual network. In addition, or in other embodiments, the base station 1612 or base station 1614 may be configured to communicate with one another via interface 1622. In embodiments where the wireless communication system 1600 is an LTE system (e.g., when the CN 1624 is an EPC), the interface 1622 may be an X2 interface. The X2 interface may be defined between two or more base stations (e.g., two or more eNBs and the like) that connect to an EPC, and/or between two eNBs connecting to the EPC. In embodiments where the wireless communication system 1600 is an NR system (e.g., when CN 1624 is a 5GC), the interface 1622 may be an Xn interface. The Xn interface is defined between two or more base stations (e.g., two or more gNBs and the like) that connect to 5GC, between a base station 1612 (e.g., a gNB) connecting to 5GC and an eNB, and/or between two eNBs connecting to 5GC (e.g., CN 1624).

The RAN 1606 is shown to be communicatively coupled to the CN 1624. The CN 1624 may comprise one or more network elements 1626, which are configured to offer various data and telecommunications services to customers/subscribers (e.g., users of UE 1602 and UE 1604) who are connected to the CN 1624 via the RAN 1606. The components of the CN 1624 may be implemented in one physical device or separate physical devices including components to read and execute instructions from a machine-readable or computer-readable medium (e.g., a non-transitory machine-readable storage medium).

In embodiments, the CN 1624 may be an EPC, and the RAN 1606 may be connected with the CN 1624 via an S1 interface 1628. In embodiments, the S1 interface 1628 may be split into two parts, an S1 user plane (S1-U) interface, which carries traffic data between the base station 1612 or base station 1614 and a serving gateway (S-GW), and the S1-MME interface, which is a signaling interface between the base station 1612 or base station 1614 and mobility management entities (MMEs).

In embodiments, the CN 1624 may be a 5GC, and the RAN 1606 may be connected with the CN 1624 via an NG interface 1628. In embodiments, the NG interface 1628 may be split into two parts, an NG user plane (NG-U) interface, which carries traffic data between the base station 1612 or base station 1614 and a user plane function (UPF), and the S1 control plane (NG-C) interface, which is a signaling interface between the base station 1612 or base station 1614 and access and mobility management functions (AMFs).

Generally, an application server 1630 may be an element offering applications that use internet protocol (IP) bearer resources with the CN 1624 (e.g., packet switched data services). The application server 1630 can also be configured to support one or more communication services (e.g., VoIP sessions, group communication sessions, etc.) for the UE 1602 and UE 1604 via the CN 1624. The application server 1630 may communicate with the CN 1624 through an IP communications interface 1632.

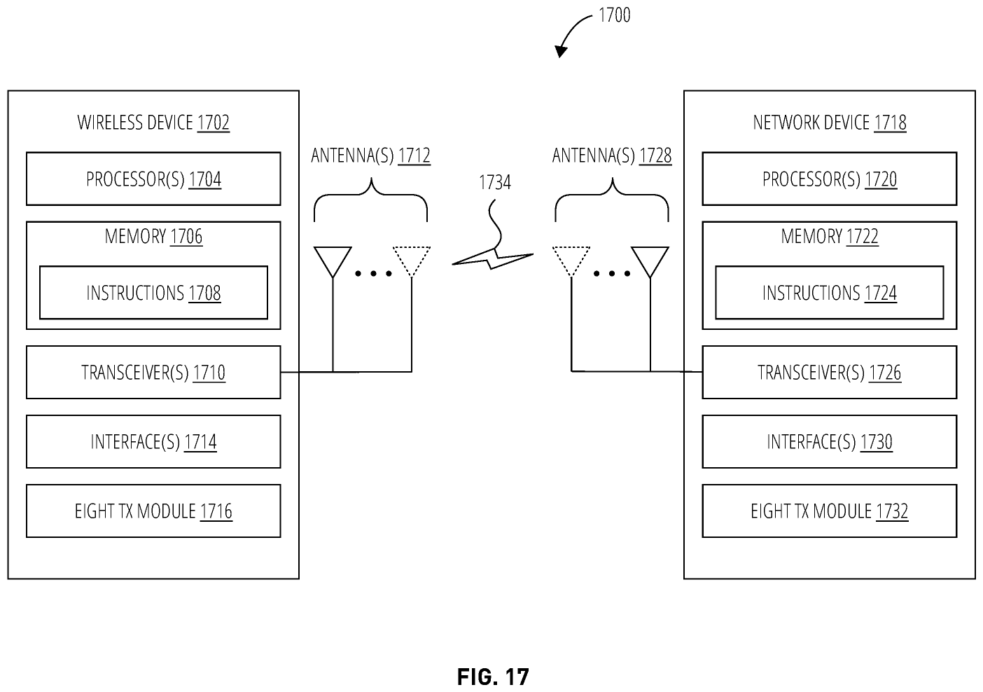

FIG. 17 illustrates a system 1700 for performing signaling 1734 between a wireless device 1702 and a network device 1718, according to embodiments disclosed herein. The system 1700 may be a portion of a wireless communications system as herein described. The wireless device 1702 may be, for example, a UE of a wireless communication system. The network device 1718 may be, for example, a base station (e.g., an eNB or a gNB) of a wireless communication system.

The wireless device 1702 may include one or more processor(s) 1704. The processor(s) 1704 may execute instructions such that various operations of the wireless device 1702 are performed, as described herein. The processor(s) 1704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1702 may include a memory 1706. The memory 1706 may be a non-transitory computer-readable storage medium that stores instructions 1708 (which may include, for example, the instructions being executed by the processor(s) 1704). The instructions 1708 may also be referred to as program code or a computer program. The memory 1706 may also store data used by, and results computed by, the processor(s) 1704.

The wireless device 1702 may include one or more transceiver(s) 1710 that may include radio frequency (RF) transmitter and/or receiver circuitry that use the antenna(s) 1712 of the wireless device 1702 to facilitate signaling (e.g., the signaling 1734) to and/or from the wireless device 1702 with other devices (e.g., the network device 1718) according to corresponding RATs.

The wireless device 1702 may include one or more antenna(s) 1712 (e.g., one, two, four, or more). For embodiments with multiple antenna(s) 1712, the wireless device 1702 may leverage the spatial diversity of such multiple antenna(s) 1712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1702 may be accomplished according to precoding (or digital beamforming) that is applied at the wireless device 1702 that multiplexes the data streams across the antenna(s) 1712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1702 may implement analog beamforming techniques, whereby phases of the signals sent by the antenna(s) 1712 are relatively adjusted such that the (joint) transmission of the antenna(s) 1712 can be directed (this is sometimes referred to as beam steering).

The wireless device 1702 may include one or more interface(s) 1714. The interface(s) 1714 may be used to provide input to or output from the wireless device 1702. For example, a wireless device 1702 that is a UE may include interface(s) 1714 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1710/antenna(s) 1712 already described) that allow for communication between the UE and other devices and may operate according to known protocols (e.g., Wi-Fi®, Bluetooth®, and the like).

The wireless device 1702 may include an eight Tx module 1716. The eight Tx module 1716 may be implemented via hardware, software, or combinations thereof. For example, the eight Tx module 1716 may be implemented as a processor, circuit, and/or instructions 1708 stored in the memory 1706 and executed by the processor(s) 1704. In some examples, the eight Tx module 1716 may be integrated within the processor(s) 1704 and/or the transceiver(s) 1710. For example, the eight Tx module 1716 may be implemented by a combination of software components (e.g., executed by a DSP or a general processor) and hardware components (e.g., logic gates and circuitry) within the processor(s) 1704 or the transceiver(s) 1710.

The eight Tx module 1716 may be used for various aspects of the present disclosure, for example, aspects of FIG. 3 through FIG. 13. The eight Tx module 1716 may be configured to perform UE operations for one or more of 8T8R antenna switching, codebook PUSCH operation, and/or non-codebook PUSCH operation, as these have been described herein.

The network device 1718 may include one or more processor(s) 1720. The processor(s) 1720 may execute instructions such that various operations of the network device 1718 are performed, as described herein. The processor(s) 1720 may include one or more baseband processors implemented using, for example, a CPU, a DSP, an ASIC, a controller, an FPGA device, another hardware device, a firmware device, or any combination thereof configured to perform the operations described herein.

The network device 1718 may include a memory 1722. The memory 1722 may be a non-transitory computer-readable storage medium that stores instructions 1724 (which may include, for example, the instructions being executed by the processor(s) 1720). The instructions 1724 may also be referred to as program code or a computer program. The memory 1722 may also store data used by, and results computed by, the processor(s) 1720.

The network device 1718 may include one or more transceiver(s) 1726 that may include RF transmitter and/or receiver circuitry that use the antenna(s) 1728 of the network device 1718 to facilitate signaling (e.g., the signaling 1734) to and/or from the network device 1718 with other devices (e.g., the wireless device 1702) according to corresponding RATs.

The network device 1718 may include one or more antenna(s) 1728 (e.g., one, two, four, or more). In embodiments having multiple antenna(s) 1728, the network device 1718 may perform MIMO, digital beamforming, analog beamforming, beam steering, etc., as has been described.

The network device 1718 may include one or more interface(s) 1730. The interface(s) 1730 may be used to provide input to or output from the network device 1718. For example, a network device 1718 that is a base station may include interface(s) 1730 made up of transmitters, receivers, and other circuitry (e.g., other than the transceiver(s) 1726/antenna(s) 1728 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1718 may include an eight Tx module 1732. The eight Tx module 1732 may be implemented via hardware, software, or combinations thereof. For example, the eight Tx module 1732 may be implemented as a processor, circuit, and/or instructions 1724 stored in the memory 1722 and executed by the processor(s) 1720. In some examples, the eight Tx module 1732 may be integrated within the processor(s) 1720 and/or the transceiver(s) 1726. For example, the eight Tx module 1732 may be implemented by a combination of software components (e.g., executed by a DSP or a general processor) and hardware components (e.g., logic gates and circuitry) within the processor(s) 1720 or the transceiver(s) 1726.

The eight Tx module 1732 may be used for various aspects of the present disclosure, for example, aspects of FIG. 3 through FIG. 13. The eight Tx module 1732 may be configured to perform network/RAN operations corresponding to one or more of 8T8R antenna switching, codebook PUSCH operation, and/or non-codebook PUSCH operation, as these have been described herein.

Embodiments contemplated herein include an apparatus comprising means to perform one or more elements of any one or more of the method 100, the method 500, the method 900, the method 1100, and the method 1400. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of any one or more of the method 100, the method 500, the method 900, the method 1100, and the method 1400. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of any one or more of the method 100, the method 500, the method 900, the method 1100, and the method 1400. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of any one or more of the method 100, the method 500, the method 900, the method 1100, and the method 1400. This apparatus may be, for example, an apparatus of a UE (such as a wireless device 1702 that is a UE, as described herein).

Embodiments contemplated herein include a signal as described in or related to one or more elements of any one or more of the method 100, the method 500, the method 900, the method 1100, and the method 1400.

Embodiments contemplated herein include a computer program or computer program product comprising instructions, wherein execution of the program by a processor is to cause the processor to carry out one or more elements of any one or more of the method 100, the method 500, the method 900, the method 1100, and the method 1400. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

Embodiments contemplated herein include an apparatus comprising means to perform one or more elements of any one or more of the method 200, the method 600, the method 1000, the method 1200, and the method 1500. This apparatus may be, for example, an apparatus of a base station (such as a network device 1718 that is a base station, as described herein).

Embodiments contemplated herein include one or more non-transitory computer-readable media comprising instructions to cause an electronic device, upon execution of the instructions by one or more processors of the electronic device, to perform one or more elements of any one or more of the method 200, the method 600, the method 1000, the method 1200, and the method 1500. This non-transitory computer-readable media may be, for example, a memory of a base station (such as a memory 1722 of a network device 1718 that is a base station, as described herein).

Embodiments contemplated herein include an apparatus comprising logic, modules, or circuitry to perform one or more elements of any one or more of the method 200, the method 600, the method 1000, the method 1200, and the method 1500. This apparatus may be, for example, an apparatus of a base station (such as a network device 1718 that is a base station, as described herein).

Embodiments contemplated herein include an apparatus comprising: one or more processors and one or more computer-readable media comprising instructions that, when executed by the one or more processors, cause the one or more processors to perform one or more elements of any one or more of the method 200, the method 600, the method 1000, the method 1200, and the method 1500. This apparatus may be, for example, an apparatus of a base station (such as a network device 1718 that is a base station, as described herein).

Embodiments contemplated herein include a signal as described in or related to one or more elements of any one or more of the method 200, the method 600, the method 1000, the method 1200, and the method 1500.

Embodiments contemplated herein include a computer program or computer program product comprising instructions, wherein execution of the program by a processing element is to cause the processing element to carry out one or more elements of any one or more of the method 200, the method 600, the method 1000, the method 1200, and the method 1500. The processor may be a processor of a base station (such as a processor(s) 1720 of a network device 1718 that is a base station, as described herein). These instructions may be, for example, located in the processor and/or on a memory of the base station (such as a memory 1722 of a network device 1718 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus of a user equipment (UE) comprising:
one or more processors; and
a memory storing instructions that, when executed by the one or more processors, configure the UE to:
receive, from a network, configuration information for one or more sounding reference signal (SRS) resource sets, each of the one or more SRS resource sets comprising a single SRS resource using eight SRS ports that is for use with an eight-transmit eight-receive (8T8R) antenna switching capability; and
transmit a first SRS resource set of the one or more SRS resource sets to the network according to the 8T8R antenna switching capability, wherein the single SRS resource of the first SRS resource set is transmitted on eight antenna ports of the UE.

2. The apparatus of claim 1, wherein the instructions, when executed by the one or more processors, further configure the UE to transmit, to the network, a first indication that the UE is capable of performing the 8T8R antenna switching capability with respect to a feature set (FS).

3. The apparatus of claim 1, wherein the instructions, when executed by the one or more processors, further configure the UE to transmit, to the network, a second indication of a downlink (DL) band that is impacted corresponding to a use of the 8T8R antenna switching capability with the first indication that the UE is capable of performing the 8T8R antenna switching capability with respect to the FS.

4. The apparatus of claim 1, wherein the instructions, when executed by the one or more processors, further configure the UE to transmit, to the network, a second indication of an uplink (UL) band that is impacted corresponding to a use of the 8T8R antenna switching capability with the first indication that the UE is capable of performing the 8T8R antenna switching capability with respect to the FS.

5. The apparatus of claim 1, wherein the one or more SRS resource sets comprises a first semi-persistent SRS (SP-SRS) resource set and a periodic SRS (P-SRS) resource set.

6. The apparatus of claim 5, wherein the one or more SRS resource sets further comprises a second SP-SRS resource set.

7. The apparatus of claim 1, wherein the one or more SRS resource sets comprises two periodic SRS (P-SRS) resource sets.

8. The apparatus of claim 1, wherein the one or more SRS resource sets comprises an aperiodic SRS (AP-SRS) resource set.

9. The apparatus of claim 8, wherein the one or more SRS resource sets further comprises a periodic SRS (P-SRS) resource set.

10. The apparatus of claim 8, the one or more SRS resource sets further comprises a first semi-persistent SRS (SP-SRS) resource set.

11. The apparatus of claim 10, wherein the one or more SRS resource sets further comprises a second SP-SRS resource set.

12. The apparatus of claim 8, wherein the one or more SRS resource sets further comprises a periodic SRS (P-SRS) resource set and a first semi-persistent SRS (SP-SRS) resource set.

13. The apparatus of claim 12, wherein the one or more SRS resource sets further comprises a second SP-SRS resource set.

14. A method of a radio access network (RAN), comprising:
transmitting, to a user equipment (UE), configuration information for one or more sounding reference signal (SRS) resource sets, each of the one or more SRS resource sets comprising a single SRS resource using eight SRS ports that is for use with an eight-transmit eight-receive (8T8R) antenna switching capability;
measuring a first SRS resource set of the one or more SRS resource sets as transmitted by the UE; and
estimating one or more characteristics of a downlink (DL) channel between the RAN and the UE based on the measurement of the first SRS resource set.

15. The method of claim 14, further comprising receiving, from the UE, a first indication that the UE is capable of performing the 8T8R antenna switching capability with respect to a feature set (FS).

16. The method of claim 15, further comprising receiving, from the UE, a second indication of a DL band that is impacted corresponding to a use of the 8T8R antenna switching capability with the first indication that the UE is capable of performing the 8T8R antenna switching capability with respect to the FS.

17. The method of claim 15, further comprising receiving, from the UE, a second indication of an uplink (UL) band that is impacted corresponding to a use of the 8T8R antenna switching capability with the first indication that the UE is capable of performing the 8T8R antenna switching capability with respect to the FS.

18. The method of claim 14, wherein the one or more SRS resource sets comprises a first semi-persistent SRS (SP-SRS) resource set and a periodic SRS (P-SRS) resource set.

19. The method of claim 18, wherein the one or more SRS resource sets further comprises a second SP-SRS resource set.

20. The method of claim 14, wherein the one or more SRS resource sets comprises two periodic SRS (P-SRS) resource sets.
